(19) United States
(12) Patent Application Publication
(10) Pub. No.: US 2015/0202922 A1
(43) Pub. Date: Jul. 23, 2015

(54) LUG NUT ADAPTER

(71) Applicant: James McKee, Riverside, CA (US)

(72) Inventor: James McKee, Riverside, CA (US)

(21) Appl. No.: 14/601,343

(22) Filed: Jan. 21, 2015

Related U.S. Application Data
(60) Provisional application No. 61/930,417, filed on Jan. 22, 2014.

(51) Int. Cl. B60B 29/00; B25B 13/48; B25B 17/00

(52) U.S. Cl. CPC B60B 29/003; B25B 17/00; B25B 13/48

(57) ABSTRACT

A lug nut adapter for actuating all of the lug nuts on a vehicle wheel at the same time. The lug nut adapter comprises a base frame defined by a rigid, circular inner portion rotatably attached to an rigid, circular outer portion through the interlocking of a drive gear with a plurality of nut gears, and includes a plurality of nut holders and a drive lug. The inner portion has fixedly attached thereto the drive gear, while the plurality of nut gears are rotatably attached to the outer portion. When the drive gear is rotated about its center axis, with the inner portion rotated on an assembled base frame, the drive gear causes the plurality of nut gears to rotate in a corresponding manner while the outer portion remains stationary.

### CROSS REFERENCE TO RELATED APPLICATIONS

This application claims the benefit of and incorporates by reference co-pending U.S. provisional patent application Ser. No. 61/930,417 filed Jan. 22, 2014.

### BACKGROUND OF THE INVENTION

1. Field of the Invention

This invention relates generally to mechanical tools and, more particularly, to an adapter for removing or installing all of the lug nuts on a vehicle wheel simultaneously.

2. Description of the Prior Art

The use of lug nuts as fasteners used to secure a wheel on a vehicle are well known. Typically, a vehicle will utilize a plurality of lug nuts, between four and six, on each wheel to secure the wheel. Lug nuts are customarily installed and removed using a lug wrench or other type of socket wrench, which is used to tighten or loosen each lug nut to a threaded wheel stud. A problem which still exists, however, is that when installing or removing lug nuts, a user is usually forced to tighten or loosen one lug nut at a time. Thus, there remains a need for an apparatus which allows all of the lug nuts on a wheel to be tighten or loosened simultaneously. It would be helpful if such a lug nut adapter utilized a gear system to transfer user motion from one location to up to six locations. It would be additionally desirable for such a lug nut adapter came with a plurality of lug nut holders to allow for rapid attachment to lug nuts.

The Applicant's invention described herein provides for an apparatus configured to attach to a plurality of lug nuts and allow them to be tightened or loosed on a vehicle wheel at the same time. The primary components of Applicant's lug nut adapter are a base frame, a drive gear, a plurality of nut gears, and a plurality of nut holders. When in operation, the lug nut adapter allows a user to engage and tighten or loosen a plurality of lug nuts simultaneously while simply turning a single wrench connected thereto. As a result, many of the limitations imposed by the prior art are removed.

### SUMMARY OF THE INVENTION

A lug nut adapter for actuating all of the lug nuts on a vehicle wheel at the same time. The lug nut adapter comprises a base frame defined by a rigid, circular inner portion rotatably attached to an rigid, circular outer portion through the interlocking of a drive gear with a plurality of nut gears, and includes a plurality of nut holders and a drive lug. The inner portion has fixedly attached thereto the drive gear, while the plurality of nut gears are rotatably attached to the outer portion. When the drive gear is rotated about its center axis, with the inner portion rotated on an assembled base frame, the drive gear causes the plurality of nut gears to rotate in a corresponding manner while the outer portion remains stationary.

Accordingly, the drive lug provides a receiving means for receiving the application of rotational force, while the drive gear and plurality of nut gears combine to provide a transfer means for transferring applied rotational force, and the plurality of nut holders provide an application means for applying transferred force.

It is an object of this invention to provide a lug nut adapter which allows all of the lug nuts on a wheel to be tighten or loosened simultaneously.

It is another object of this invention to provide a lug nut adapter that utilizes a gear system to transfer user motion from one location to up to six locations.

It is yet another object of this invention to provide a lug nut adapter that came with a plurality of lug nut holders to allow for rapid attachment to lug nuts.

These and other objects will be apparent to one of skill in the art.

### BRIEF DESCRIPTION OF THE DRAWINGS

FIG. 1 is a top plan view of the a lug nut adapter built in accordance with the present invention.

FIG. 2 is a bottom plan view of the a lug nut adapter built in accordance with the present invention

### DETAILED DESCRIPTION OF THE INVENTION

Inventor(s): MCKEE, James Non-provisional Patent Application

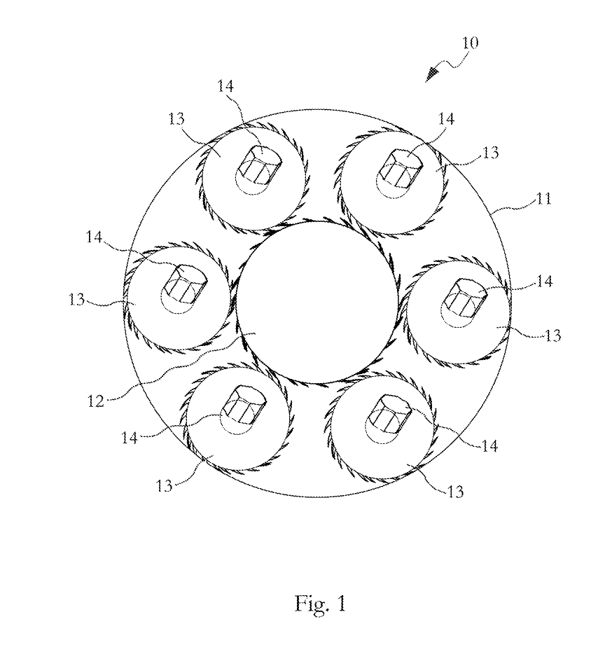

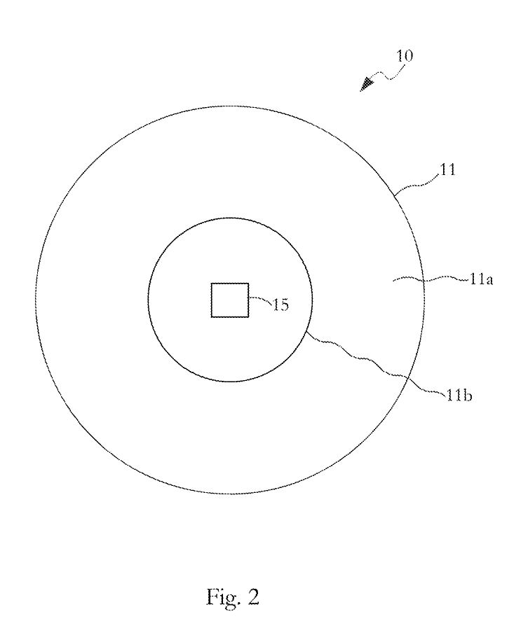

Referring now to the drawings and in particular FIGS. 1 and 2, a lug nut adapter 10 is shown having a base frame 11, a drive gear 12, a plurality of nut gears 13, a plurality of nut holders 14, and a drive lug 15. The base frame 11 is defined by a rigid, circular outer portion 11a and an rigid, circular inner portion 11b. The inner portion 11b has fixedly attached thereto the drive gear 12, while the plurality of nut gears 13 are rotatably attached to the outer portion 11a. The base frame 11 is assembled with the inner portion 11b rotatably attached to the outer portion 11a through the interlocking of the drive gear 12 with the plurality of nut gears 13. In this manner, the drive gear 12 is rotatable about its center axis and when the inner portion 11b is rotated on an assembled base frame 11, the drive gear 12 rotates and causes the plurality of nut gears 13 are rotate in a corresponding manner, while the outer portion 11a remains stationary. The drive lug 15 is fixedly attached to the inner portion 11b on the opposite side of the drive gear 12 such that when it is rotated, the inner portion 11b and the drive gear 12 rotate in the same direction.

Each nut gear 13 has fixedly attached thereto a nut holder 14 which is configured to selectively engage a conventional lug nut (not shown) in the same manner as the socket on a discrete lug wrench. In this manner, when the nut holders 14 are placed on the lug nuts of a vehicle wheel, they can each be rotated through the application of rotational force on the nut gears 13 to which they are attached. Due to the nature of the nut gears 13 engagement with the drive gear 12, when rotational force is exerted on the drive gear 12, it causes the nut holders 14 to rotate in concert by way of the rotation of each nut gear 13. It is contemplated that such rotational force can be supplied through by engaging a conventional socket wrench, including a lug wrench, with the drive lug 15 and turning.

In an alternate embodiment, a lug nut adapter built in accordance with the present invention includes four nut gears, each having attached thereto a nut holder. Such an embodiment is utilized on vehicle wheels having four wheel studs.

In yet another alternate embodiment, a lug nut adapter built in accordance with the present invention includes five nut gears, each having attached thereto a nut holder. Such an embodiment is utilized on vehicle wheels having five wheel studs.

In still another alternate embodiment, a lug nut adapter built in accordance with the present invention can be selectively sized through interchangeable outer portions, whereby outer portions of varying sizes can be alternatively attached to one inner portion.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A lug nut adapter, comprising:
a base frame having a front side and a rear side, said base frame defining by a discrete first portion and a discrete second portion;
a drive lug integral with said second portion on the front side of the base frame; and
a plurality of nut holders integral with said first portion on the rear side of the base frame, wherein said nut holders and said drive lug are configured such that the application of rotational force causes each of the nut holders to be rotated.

2. The lug nut adapted of claim 1, wherein the first portion defines a discrete rigid, circular outer portion.

3. The lug nut adapted of claim 2, wherein the second portions defines a discrete rigid, circular inner portion.

4. The lug nut adapted of claim 3, additionally comprising:
a drive gear integral with said second portion and said drive lug;
a plurality of nut gears integral with said first portion and said plurality of nut holders, wherein said nut holders and said drive lug are configured such that the application of rotational force causes each of the nut holders to be rotated through the interlocking of the drive gear and the plurality of nut gears.

5. The lug nut adapted of claim 4, wherein six nut holders are integral with said first portion.

6. The lug nut adapted of claim 5, wherein six nut gears integral with said first portion and each nut gear is integral with a single nut holder.

7. The lug nut adapted of claim 1, wherein the second portions defines a discrete rigid, circular inner portion.

8. The lug nut adapted of claim 1, additionally comprising:
a drive gear integral with said second portion and said drive lug;
a plurality of nut gears integral with said first portion and said plurality of nut holders, wherein said nut holders and said drive lug are configured such that the application of rotational force causes each of the nut holders to be rotated through the interlocking of the drive gear and the plurality of nut gears.

9. The lug nut adapted of claim 1, wherein six nut holders are integral with said first portion.

10. A lug nut adapter, comprising:
a base frame having a front side and a rear side;
a receiving means for receiving the application of rotational force on the front side;
a transfer means for transferring applied rotational force; and
an application means for applying transferred force of the rear side.
